(19) United States
(12) Patent Application Publication
(10) Pub. No.: US 2002/0188502 A1
(43) Pub. Date: Dec. 12, 2002

(54) Systems and methods of product promotion

(76) Inventor: Ken R. Powell, Athens, GA (US)

Correspondence Address: Law Office of Jerome D. Jackson, Suite 100, 211 N. Union Street, Alexandria, VA, 22314, US

(21) Appl. No.: 09/825,939

(22) Filed: Apr. 5, 2001

(51) Int. Cl. G06F 17/60; G06G 1/12

(52) U.S. Cl. 705/14; 705/39; 705/21

(57) ABSTRACT

Systems and methods of promotion within a commercial system. Manufacturers fund a product discount specific to a retailer, thereby both stimulating sales of the product and stimulating visits to the retailer.

### BACKGROUND OF THE INVENTION

1. Field of the Invention

This invention relates generally to a commercial system and, more particularly, to a commercial system providing purchase incentives to customers.

2. Description of Related Art

Product promotions employing price discounts are a popular means to stimulate sales of products such as grocery store items. For example, discount coupons issued by a manufacturer are one type of product promotion. Product price discounts specific to a retailer are another type of product promotion. Product price discounts specific to a retailer act to promote both the product and the retailer.

### SUMMARY OF THE INVENTION

It is an object of the present invention to provide systems and methods of effecting price discounting to effect product promotions.

To achieve this and other objects of the present invention, there is a method for a system including a retailer, and a plurality of manufacturers each associated with a respective product. The method comprises enabling a price adjustment for a first purchase with the retailer; effecting the first purchase with the retailer; generating a first signal corresponding to the first purchase and sending the first signal on a first signal path; generating a second signal corresponding to the first purchase and sending the second signal on a second signal path; receiving the first signal from the first signal path, and the second signal from the second signal path; and processing the first and second signals received in the previous step, to generate a third signal corresponding to an offset of funds between a selected manufacturer and the retailer, wherein the manufacturer is selected depending on a product subjected to the first purchase.

According to another aspect of the present invention, there is a processing system in a first system including a retailer, and a plurality of manufacturers each associated with a respective product. The processing system comprises a generator, in the retailer, that generates a first signal corresponding to a price-adjusted first purchase with a retailer and sending the first signal on a first signal path; a generator, in the retailer, that generates a second signal corresponding to the price-adjusted first purchase and sending the second signal on a second signal path; and a processor that receives the first and second signals, to generate a signal corresponding to an offset of funds between a selected manufacturer and the retailer, wherein the manufacturer is selected depending on a product subjected to the first purchase.

According to another aspect of the present invention, there is a processing system in a first system including a retailer, and a plurality of manufacturers each associated with a respective product, a processing system comprising: means for enabling a price adjustment for a first purchase with the retailer; means for effecting the first purchase with the retailer; means for generating a first signal corresponding to the first purchase and sending the first signal on a first signal path; means for generating a second signal corresponding to the first purchase and sending the second signal on a second signal path; means for receiving the first signal from the first signal path, and the second signal from the second signal path; and means for processing the first and second signals received in the previous step, to generate a signal corresponding to an offset of funds between a selected manufacturer and the retailer, wherein the manufacturer is selected depending on a product subjected to the first purchase.

### BRIEF DESCRIPTION OF THE DRAWINGS

FIG. 1 is a diagram of a commercial system in accordance with a preferred embodiment of the present invention.

FIG. 2 is a view of part of a store in the preferred system of FIG. 1.

FIGS. 3A and 3B are another view of another part of the store in the preferred system.

FIG. 4 is a sign in the store of FIGS. 2, 3A, and 3B.

FIG. 5 is another sign in the store of FIGS. 2, 3A, and 3B.

FIG. 6 is a flowchart of a process performed in the preferred system.

FIG. 7A is a diagram of circuitry in a checkout station of the store shown in FIGS. 2, 3A, and 3B.

FIG. 7B is a diagram of a computer in the store shown in FIGS. 2,3A, and 3B.

FIG. 8 is a printout representing a signal generated in the preferred system.

FIG. 9 is a data flow diagram for explaining a process used to generate the signal represented by FIG. 8.

FIG. 10 is a diagram showing data structures in the preferred system.

FIG. 11 is a diagram showing other data structures in the preferred system.

FIGS. 12A and 12B are a flowchart showing some of the processing of FIG. 6 in more detail.

The accompanying drawings, which are incorporated in and which constitute a part of this specification, illustrate embodiments of the invention. Throughout the drawings, corresponding parts are labeled with corresponding reference numbers.

### DESCRIPTION OF THE PREFERRED EMBODIMENTS

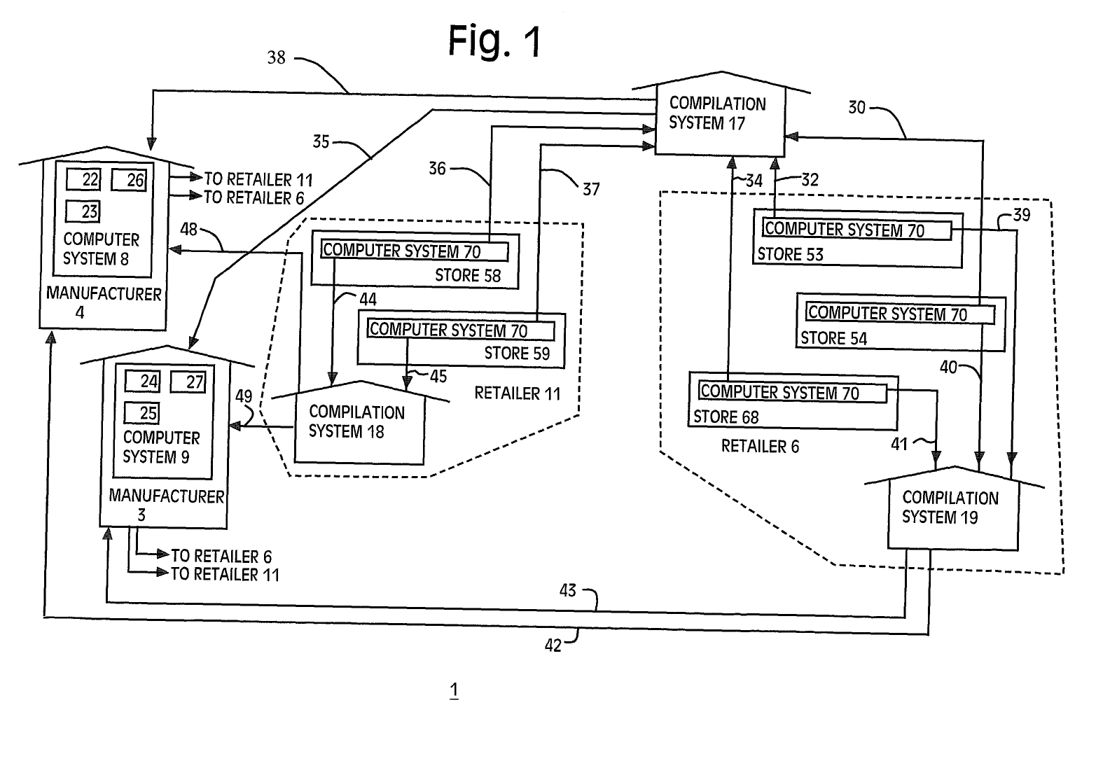

FIG. 1 shows system 1, a system of commercial promotion in accordance with a preferred embodiment of the present invention. Compilation system 17 serves retailer 6, retailer 11, manufacturer 3, and manufacturer 4. Retailers 6 and 11 are in mutual competition. Retailer 6 includes store 53, store 54, store 68, and compilation system 19. Retailer 11 includes store 58, store 59, and compilation system 18.

The spatial location on the drawing sheet of FIG. 1 does not indicate geographic location. Stores within a particular retailer may be widely separated geographically, and stores of different retailers may be relatively close. For example, store 58 in retailer 11 may be in the same neighborhood as store 54 in retailer 6.

Manufacturers 3 and 4 are in mutual competition. Manufacturer 3 is the Lighthouse Company. The product line of the Lighthouse Company includes Lighthouse Light Bulbs. To stimulate sales, manufacturer 3 finances product promotions consisting essentially of advertised customer discounts on sales of Lighthouse Light Bulbs occurring only within retailer 6. These promotions specific to retailer 6 are financed under budget 24 in manufacturer 3.

To stimulate sales, manufacturer 3 also issues printed coupons, redeemable for a discount on Lighthouse Light Bulbs. Coupons for Lighthouse Light Bulbs are distributed in newspapers, for example, and are redeemable at any retailer, including retailers 6 and 11. Coupons are financed under budget 25 in manufacturer 3.

Manufacturer 4 is the Delta Company. The product line of the Delta Company includes Delta Detergent. To stimulate sales, manufacturer 4 finances product promotions consisting essentially of advertised customer discounts on sales of Delta Detergent occurring only within retailer 6. These promotions specific to retailer 6 are financed under budget 22 in manufacturer 4.

To stimulate sales, manufacturer 4 also issues printed coupons, redeemable for a discount on Delta Detergent. Coupons for Delta Detergent are distributed in newspapers, for example, and are redeemable at any retailer, including retailers 6 and 11. Coupons are financed under budget 23 in manufacturer 4.

Processes performed by the circuitry of the exemplary embodiments are described below. In this Patent Application, the word circuitry encompasses dedicated hardware, and/or programmable hardware, such as a CPU or reconfigurable logic array, in combination with programming data, such as sequentially fetched CPU instructions or programming data for a reconfigurable array.

In reliance on signals generated by system 1, manufacturer 4 reimburses retailer 6 for the discount given to customers, as described in more detail below.

Retailer 6 is the ECO grocery store chain. Retailer 6 includes grocery stores 53, 54 and 68. Computer systems 70 in stores 53, 54 and 68 detect discounted purchases and send a purchase report to compilation center 17, via telecommunications signal paths 30, 32, and 34. Compilation center 17, located in Athens, Ga. receives signals from signal paths 30, 32, and 34 to generate a report for manufacturer 4, and sends the report to manufacturer 4 via signal path 38.

Computer systems 70 in stores 53, 54, and 68 also send a purchase report to compilation system 19, in retailer 6, via telecommunication signal paths 39, 40,and 41. Compilation system 19, which is an accounting center of retailer 6, receives signals from signal paths 39, 40, and 41 to generate a report for manufacturer 4, and send the report to manufacturer 4 via signal path 42.

Compilation center 17 also receives signals from signal path 30, 32, and 34 to generate a report for manufacturer 3, and sends the report to manufacturer 3 via signal path 35. Manufacturer 3 receives the reports from center 17 and center 19. In response to the reports from center 17 and center 19, manufacturer 3 generates reimbursement for retailer 6.

To stimulate sales, manufacturer 4 finances product promotions consisting essentially of advertised customer discounts on sales of Delta Detergent occurring only within retailer 6. These promotions specific to retailer 6 are financed under budget 22 in manufacturer 4.

To stimulate sales, manufacturer 4 finances product promotion consisting essentially of customer discounts on sales of Delta Detergent occurring within retailer 11. These promotions specific to retailer 11 are financed under budget 26 in manufacturer 4.

Thus, manufacturer 4 includes computer system 8 storing budget 22, which is a type of monetary amount for a product promotion and discount program for Delta Detergent. Computer system 8 also stores budget 26, which is a type of monetary amount for another product promotion and discount program for Delta Detergent. Computer system 8 also stores budget 23, which is a type of monetary amount for yet another product promotion and discount program for Delta Detergent.

To stimulate sales, manufacturer 3 finances product promotions consisting essentially of advertised customer discounts on sales of Lighthouse Light Bulbs occurring only within retailer 6. These promotions specific to retailer 6 are financed under budget 24 in manufacturer 3.

To stimulate sales, manufacturer 3 finances product promotion consisting essentially of customer discounts on sales of Lighthouse Light Bulbs occurring within retailer 11. These promotions specific to retailer 11 are financed under budget 27 in manufacturer 3.

Thus, manufacturer 3 includes computer system 9 storing budget 24, which is a type of monetary amount for a product promotion and discount program for Lighthouse Light Bulbs. Computer system 9 also stores budget 27, which is a type of monetary amount for another product promotion and discount program for Lighthouse Light Bulbs. Computer system 9 also stores budget 25, which is a type of monetary amount for yet another product promotion and discount program for Lighthouse Light Bulbs.

Retailer 11 is the Healthy grocery store chain. Retailer 11 operates grocery stores 58 and 59. Computer systems 70 in stores 58 and 59 detect discounted purchases and send a purchase report to compilation system 17, via telecommunications signal paths 36 and 37.

Computer systems 70 in stores 58 and 59 also send a purchase report to compilation system 18, in retailer 11, via telecommunication signal paths 44 and 45. Compilation system 18, which is an accounting center of retailer 11, receives signals from signal paths 44 and 45 to generate a report for manufacturer 4, and send the report to manufacturer 4 via signal path 48.

Compilation center 17 also receives signals from signal paths 36 and 37 to generate a report for manufacturer 3, and sends the report to manufacturer 3 via signal path 35. Manufacturer 3 receives the reports from center 17 and center 18. In response to the reports from center 17 and center 18, manufacturer 3 generates reimbursement for retailer 11.

Compilation system 17 receives signals from signal paths 36 and 37 to generate a report for manufacturer 3, and sends the report to manufacturer 3 via signal path 35. Manufacturer 3 receives the report from system 17. In response to the report from system 17, manufacturer 3 generates reimbursement for retailer 6. In the response to the report from system 17, manufacturer 3 generates reimbursement data for retailer 11.

In FIG. 1, “TO RETAILER 6” designates a dollar amount, or some other benefit, flowing to retailer 6; and “TO RETAILER 11” designates a dollar amount, or some other benefit, flowing to retailer 11.

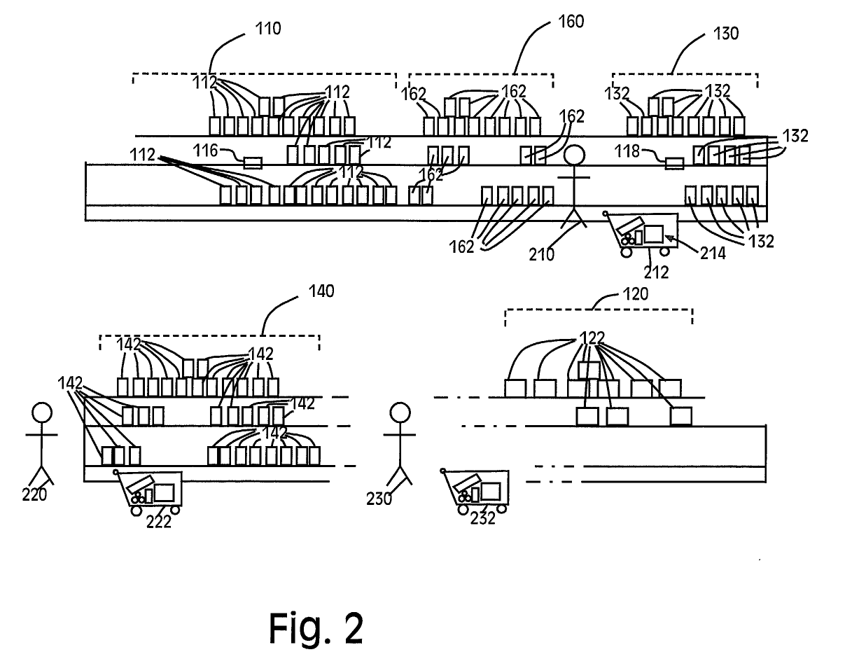

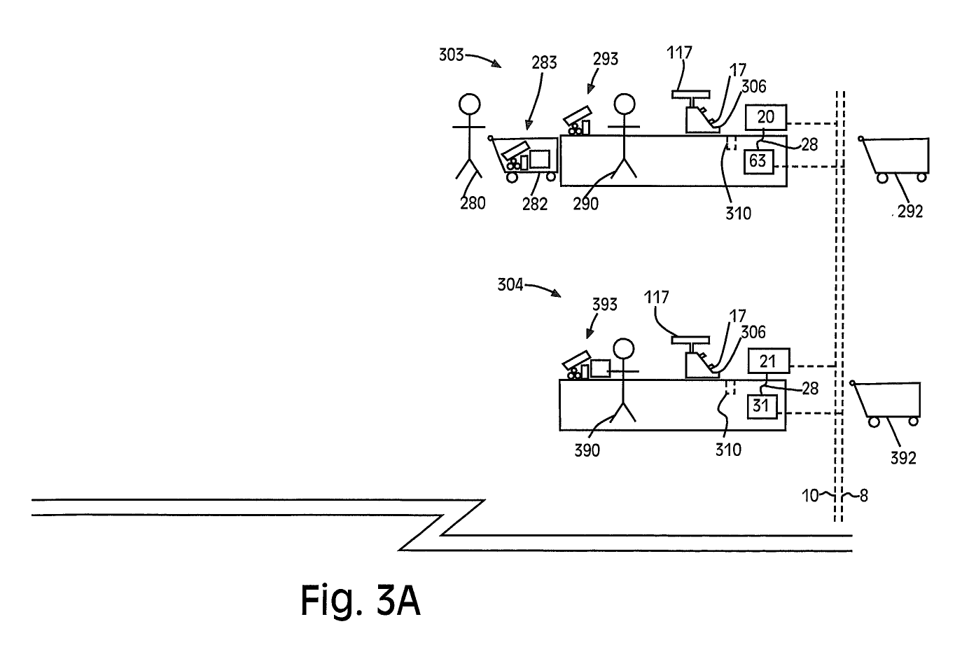

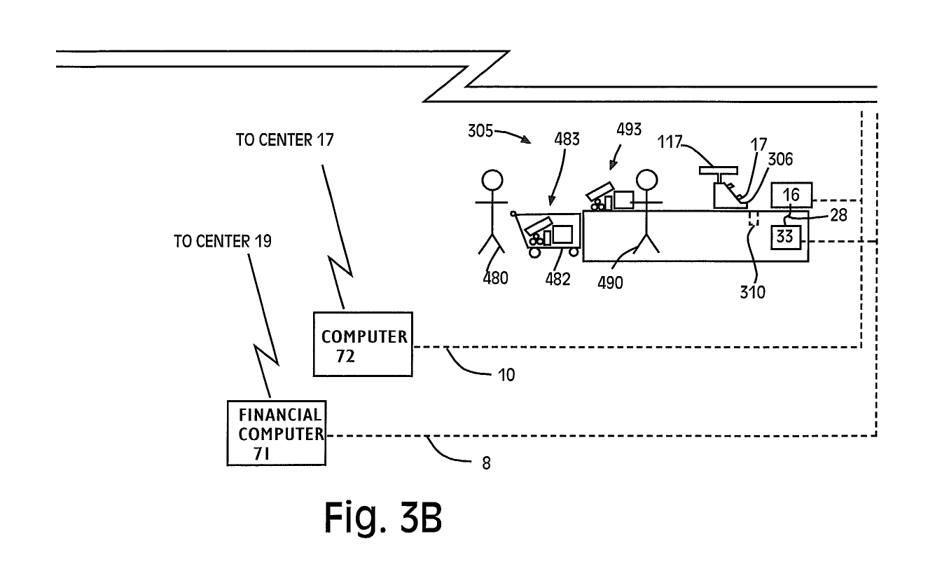

FIGS. 2, 3A, and 3B are each a partial view of store 54 in retailer 6. Store 54 has a plurality of product areas, each corresponding to a respective product. For example, product area 110 has bottles 112 of Delta Detergent. Each bottle of detergent 112 has a common Universal Product Code (UPC) symbol, which is a group of parallel lines encoding a number typically called a “bar code.” This number is part of a product identification system documented by the Uniform Code Council, Inc., Dayton, Ohio. The first digit is a number system character, which in this case is 0. The next five digits are a manufacturer ID. The next 5 digits are an item number. The last digit is a check digit. UPC product code 0 17075 42312 3 uniquely identifies Delta Detergent.

Product area 120 has boxes of pasta 122. Each box of pasta 122 has a common UPC symbol encoding a UPC product code (0 17031 00005 3) uniquely identifying Old World pasta.

Product area 130 has boxes of light bulbs 132. Each box of light bulbs 132 has a common UPC symbol encoding a UPC product code (0 17054 generator 1027 6) uniquely identifying Lighthouse light bulbs. Similarly, other product areas in store 54 each have a set of respective products contiguously grouped together. Respective units of a certain product have a common UPC symbol, different from UPC symbols on units of other products, that uniquely identifies the certain product. Respective units of a certain product also have a common human readable word label, different from labels on units of other products, that uniquely identifies the certain product with words. Product area 140 has bottles of ABC brand ketchup 142 contiguously grouped together on shelves. Product area 160 has loaves of Boxer brand bread 162 contiguously grouped together on shelves.

From time to time, system 1 promotes certain products with a discount pricing display. For example, FIG. 2 shows shelf label 116 adjacent to Delta Detergent and shelf label 118 adjacent to Lighthouse Light Bulbs.

Checkout station 303 includes cash register system 63 and data compilation system 20. Data compilation system 20 communicates with cash register system 63 via serial data cable 28. Checkout station 304 includes cash register system 31 and data compilation system 21. Data compilation system 21 communicates with cash register system 31 via serial data cable 28. Checkout station 305 includes cash register system 33 and data compilation system 16. Data compilation system 16 communicates with cash register system 33 via serial data cable 28. Store 54 includes network cable 8 and network cable 10.

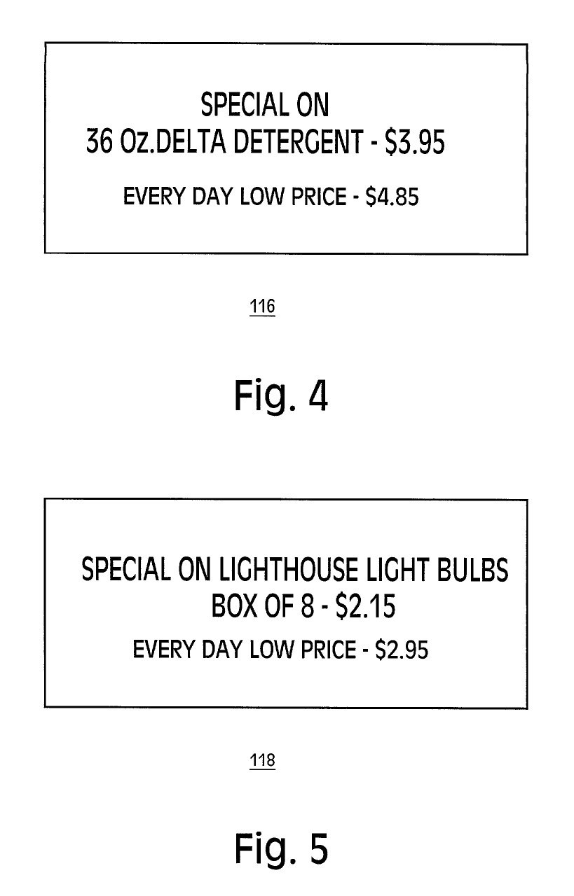

FIG. 4 shows shelf label 116 in more detail.

FIG. 5 shows shelf label 118 in more detail.

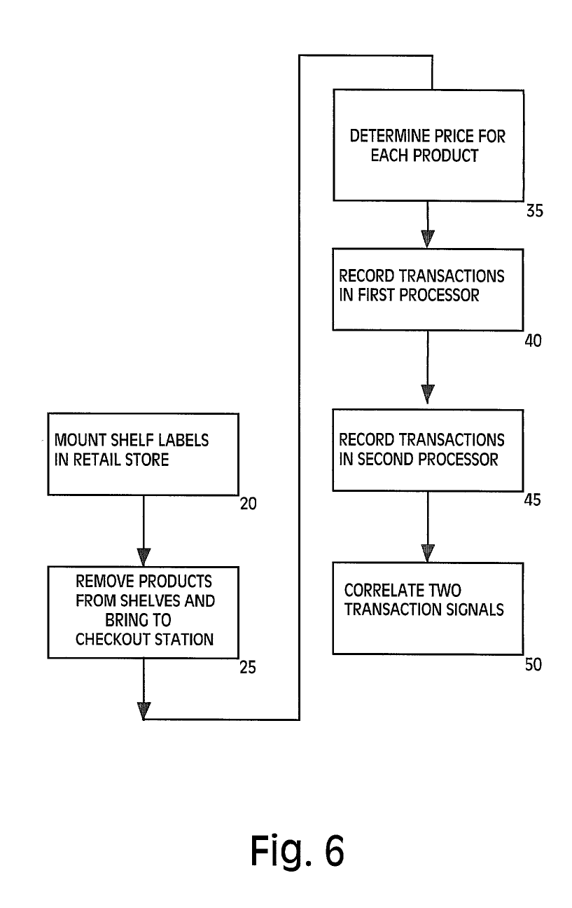

FIG. 6 shows a processing performed in the preferred system. Store personnel mount store labels, such as labels 116 and 118, in a store, such as store 54. (step 20). At store 54, customers removes products from shelves and bring the products to checkout station 303, for example. (step 25). More specifically, each customer tows a shopping cart to hold selected products. Customer 210 tows cart 212, customer 220 tows cart 222, customer 230 tow cart 232, customer 480 tows cart 482, customer 280 tows cart 282, and customer 390 tows cart 392. A customer removes a product from a shelf and places the removed product into his cart. The customer thus shops throughout the store.

Checkout station 303 then scans the products and store 54 determines a price for each product depending on a number of factors, including whether the product is subject to a manufacturer-funded discount specific to retailer 6, as indicated by a shelf label such as label 116 or 118. (step 35). Station 303 receives a message from financial computer 71 containing price information for the scanned product. In the case of a product subject to the manufacturer-funded discount, the message from financial computer 71 may contain the discounted price (the adjusted price). Alternately, station 303 may itself determine whether a product is subject to a discount, by communication with another processor, for example, and then adjust a basic price, received in the message from computer 71, to obtain the discounted price. In other words, the discount may manifest itself in station 303 merely by displaying and charging a certain price or, alternately, the discount may also manifest itself with a different program execution path in station 303, via a User Exit for example.

Store 54 temporarily stores a record of the transaction in computer 71 (step 40). Store 54 temporarily stores another record of the transaction on computer 72 (step 45). Manufacturer 4 correlates the two records stored in steps 40 and 45 (step 50).

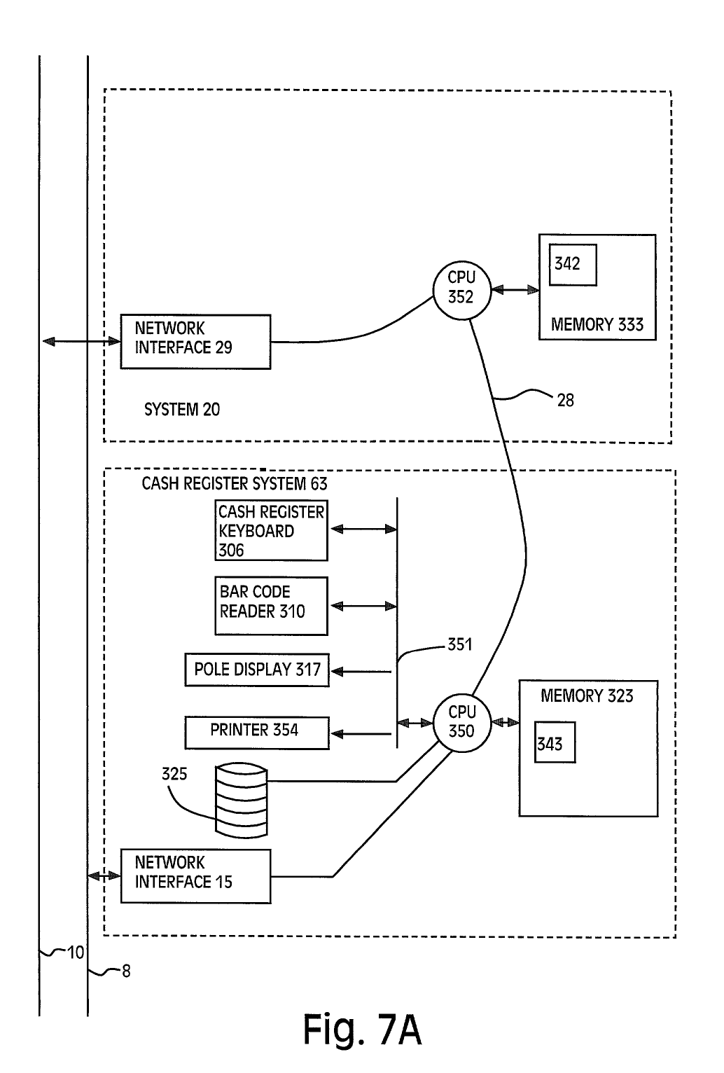

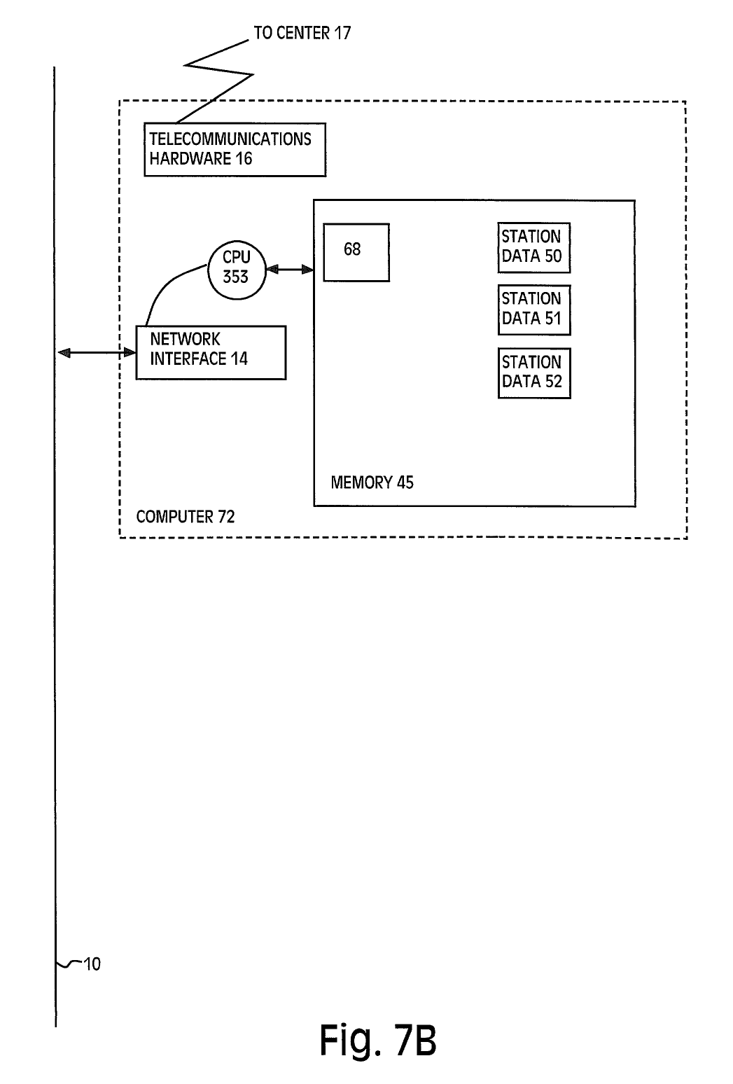

FIGS. 7A and 7B are a block diagram of computer 72 and checkout station 303. Checkout station 303 includes cash register system 63 and data compilation system 20. Data compilation system 20 communicates with cash register system 63 via serial data cable 28. Cash register system 63 includes an IBM 4680-4690 Point of Sale System. CPU 350 executes instructions 343 in random access, addressable memory 323. CPU 350 communicates with cash register keyboard 306, bar code reader 310, pole display 317, and printer 354 via RS-485 serial bus 351. CPU 350 send data to, and receives data from cable 8 via network interface 15. Cash register keyboard 306 allows manual entry of alpha-numeric-data. Bar code reader 310 generates a bar code signal, and sends the bar code signal to CPU 350. Poll display 317 displays product data in response to signals from CPU 350. Disk 325 provides long term storage.

In system 20, CPU 352 executes program 342 in random access, addressable memory 333. CPU 352 send data to, and receives data from cable 10 via network interface 29.

A physical layer includes an RS-232 asynchronous serial connection on which CPU 350 in system 63 communicates with CPU 352 in system 20 via RS232 line 28.

A data link layer between systems 63 and 20 includes a frame with a start code octet, one or more data octets, a checksum octet, and an end code octet. Every frame transmitted requires an ACK/NAK response. When system 20 receives a frame with a correct checksum, system 20 sends an ACK response; otherwise system 20 sends a NAK response. If system 63 does not receive a response within a reasonable amount of time, system 63 declares a timeout condition and resend the frame.

An application layer between systems 63 and 20 includes a series of commands and responses, as discussed in more detail below.

Table 1 below summarizes an Item Committed command sent from system 63 to system 20 in the application layer supported by the data link layer, which in turn is supported by the physical layer. Five parameters for the Item Committed command include:

TABLE 1

| | |
|---|---|
| P0 | Sales type |
| | 0 × 30 = Normal Sales |
| | 0 × 31 = Refund/Return |
| | 0 × 34 = Cancel Normal Sales |
| | 0 × 35 = Cancel Refund/Return |
| P1 | UPC product code. (12 digits, packed decimal). |
| P2 | Price. (4 digits, packed decimal). |
| P3 | Quantity. (3 digits, packed decimal). |
| P4 | Weight. (6 digits, packed decimal). |

It is presently preferred that sending of commands from system 63 be implemented by customizing system 63 with a “user exits,” which are a standardized mechanism by which the IBM 4860-4690 system calls custom routines, as described in the IBM 4680-4690 Supermarket Application: Programming Guide, SC30-3634, Third Edition (January 1997). Some exits employed in this customization may include TSUPEC2—After a Customer Checkout Transaction is Completed, and TSUPEC14—After Reading the Keyboard/Scanner, and TSUPEC23—Before Writing a Line to the Display.

Checkout stations 304 and 305 each have the same circuitry as that of as checkout station 303.

When system 20 receives an application layer command from system 63, system 20 sends the command to computer 72. In response to receiving a command, computer 72 sends any needed response to system 20, and system 20 then sends the response to system 63.

During a checkout transaction for a customer at station 303, computer 72 maintains station data 50. Station data 50 includes data about transactions at checkout station 303, including a list of products selected by the customer.

During the checkout transaction for a customer at station 304, computer 72 maintains station data 51. Station data 51 includes data about transactions at checkout station 304, including a list of products selected by the customer.

During the checkout transaction for a customer at station 305, computer 72 maintains station data 52. Station data 52 includes data about transactions at checkout station 305, including a list of products selected by the customer.

In computer 72, CPU 353 executes instructions 68 in random access, addressable memory 45. CPU 353 sends data to, and receives data from, cable 10 via network interface 14.

When computer 72 receives an Item Committed command identifying a product selected by a customer at station 303, computer 72 adds the product to a basket list in station data 50.

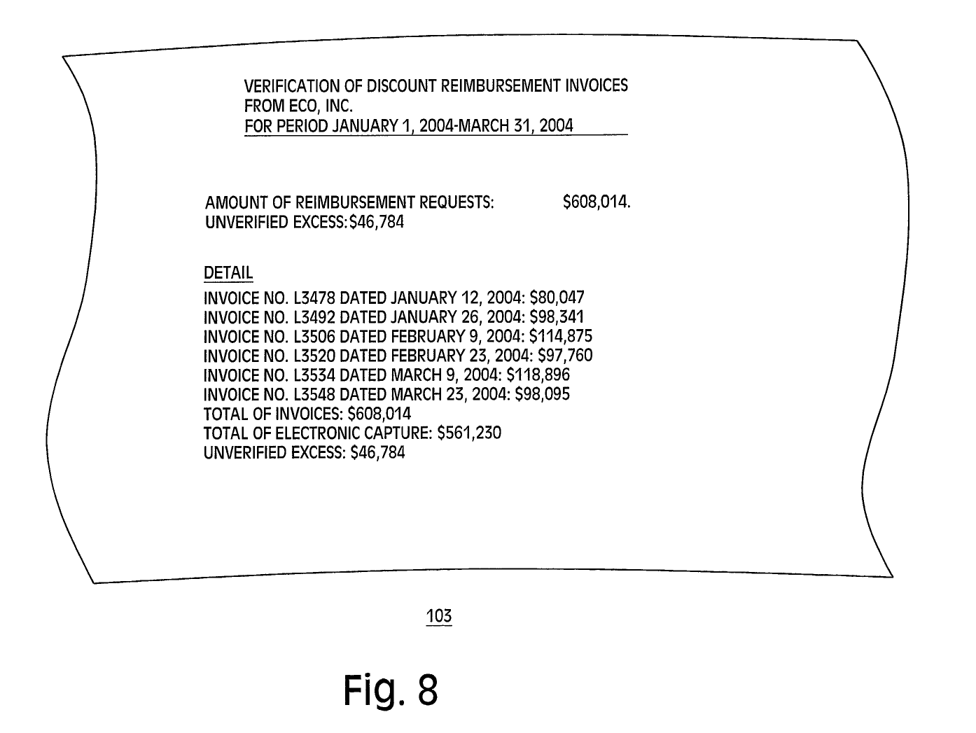

Computer 72 sends a report to center 17. In response to the report, center 17 generates a composite report and sends the composite report to manufacturer 3 via signal path 35. Manufacturer 3 processes this composite report with reimbursement requests, represented by signal path 43 in FIG. 1, to verify accuracy of reimbursement requests. In other words, manufacturer 3 generates a signal responsive to signals on signal path 35 and signal path 43. An example of such a signal is shown on hardcopy printout 103 of FIG. 8.

Center 17 also generates a composite report for manufacturer 4 and sends the composite report to manufacturer 4 via signal path 38. Manufacturer 4 processes this composite report with reimbursement requests, represented by signal path 42 in FIG. 1, to verify accuracy of reimbursement requests. In other words, manufacturer 4 generates a signal responsive to signals on signal path 38 and signal path 42. This signal generated by manufacturer 4 is analogous to the signal shown on hardcopy printout 103 of FIG. 8.

In summary, system 1 essentially enables a type of price discount with a contract between a manufacturer and a retailer, and with circuitry in the manufacturer and the retailer. For example, system 1 sets up a type of retail price adjustment, by allocating a budget 26 and creating a contract between manufacturer 4 and retailer 11. The contract provides for a retail price of $3.95, instead of $4.85, for Delta Detergent and for manufacturer 4 to reimburse, or otherwise credit, retailer 11 for each consumer purchase made at the discount price. Manufacturer 4 receives a set of data from signal path 48 and another set of data from signal path 38. Manufacturer 4 processes these two sets of data to generate a monetary amount corresponding to an offset of funds between manufacturer 4 and retailer 11.

For example, system 1 allocates a budget 22 and creates a contract between manufacturer 4 and retailer 6. The contract provides for a retail price of $3.95, instead of $4.85, for Delta Detergent and for manufacturer 4 to reimburse, or otherwise credit, retailer 6 for each consumer purchase made at the discount price. Manufacturer 4 receives a set of data from signal path 42 and another set of data from signal path 38. Manufacturer 4 processes these two sets of data to generate a monetary amount corresponding to an offset of funds between manufacturer 4 and retailer 6.

For example, system 1 allocates a budget 27 and creates a contract between manufacturer 3 and retailer 11. The contract provides for a retail price of $2.15, instead of $2.95, for Lighthouse Lightbulbs and for manufacturer 3 to reimburse, or otherwise credit, retailer 11 for each consumer purchase made at the discount price. Manufacturer 3 receives a set of data from signal path 48 and another set of data from signal path 35. Manufacturer 3 processes these two sets of data to generate a monetary amount corresponding to an offset of funds between manufacturer 3 and retailer 11.

For example, system 1 allocates a budget 24 and creates a contract between manufacturer 3 and retailer 6. The contract provides for a retail price of $2.15, instead of $2.95, for Lighthouse Lightbulbs and for manufacturer 3 to reimburse, or otherwise credit, retailer 6 for each consumer purchase made at the discount price. Manufacturer 3 receives a set of data from signal path 43 and another set of data from signal path 35. Manufacturer 3 processes these two sets of data to generate a monetary amount corresponding to an offset of funds between manufacturer 3 and retailer 6.

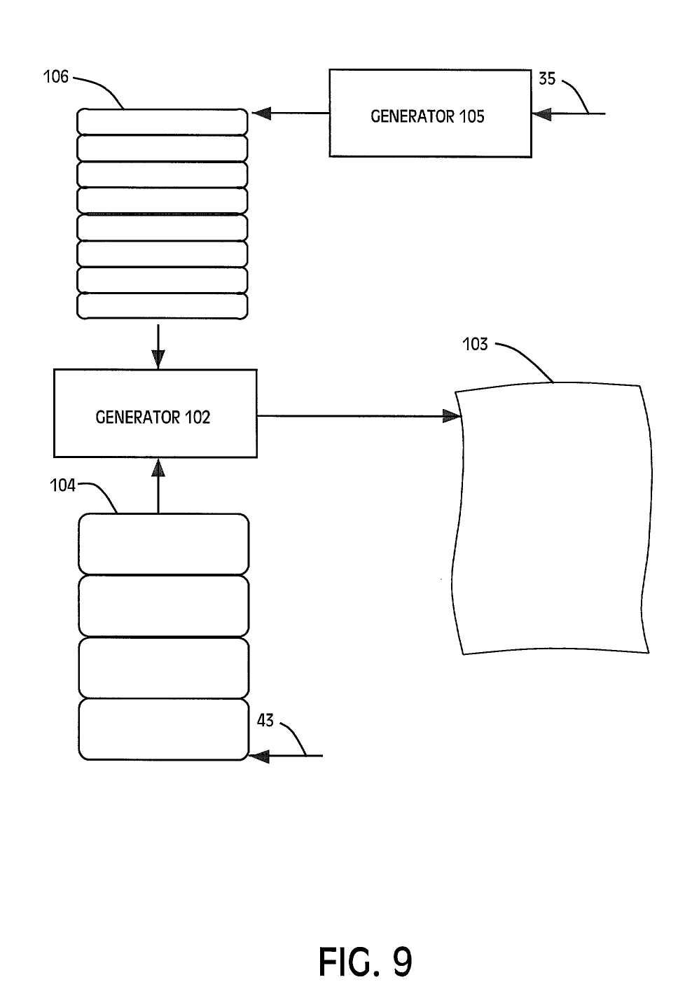

FIG. 9 shows generators 105 and 102 in computer system 9 in manufacturer 3 for verifying reimbursement request from retailer 6 or retailer 11. For example, to verify reimbursement request for retailer 6, generator 102 receives reimbursement request invoices records 104 via signal path 43. Generator 102 correlates records 106 with records 104 to generate a report 103. Report 103 indicates when records 104 request reimbursement for purported transactions having no corresponding record in records 106.

Computer system 8 in manufacturer 4 also includes a generator 105 and a generator 102.

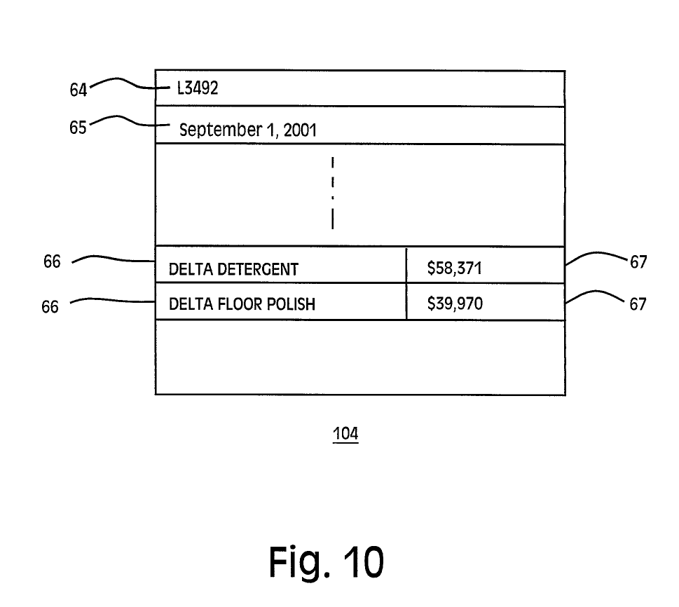

FIG. 10 shows a record 104 in more detail. Record 104 includes an invoice field 64 containing an invoice identifier, a date field 65, and field pairs 66-67. In each field pair 66-67, field 66 contains a product identification code and field 67 contains a reimbursement amount for the product in the corresponding field 66.

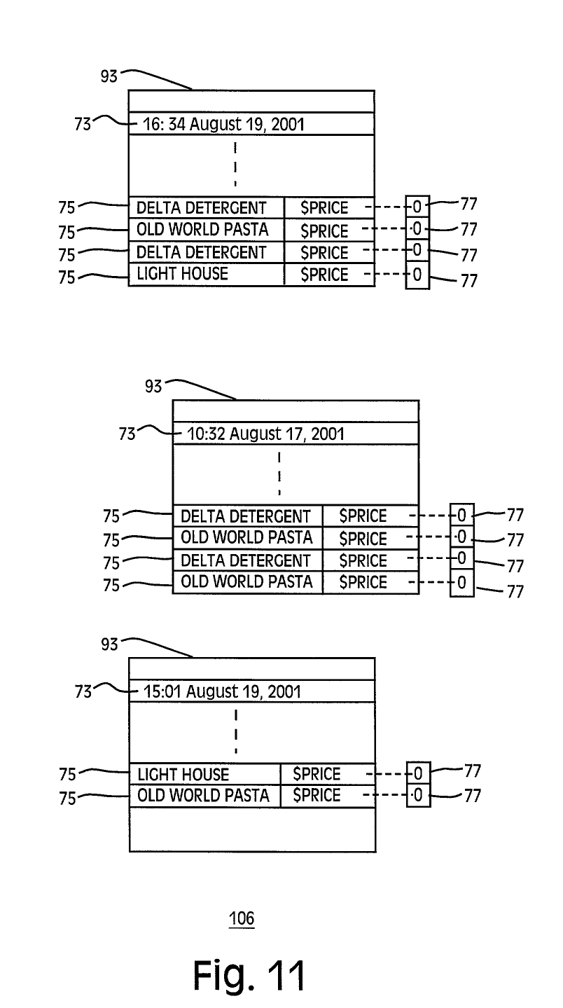

FIG. 11 shows records 106 in more detail. Records 106 include multiple checkout transaction records 93 received from compilation system 17 via signal path 35. Each record 93 includes a list of UCC Product Code of items purchased during the checkout transaction. Each record 93 includes a date-time field 73, indicating the time of day and date that a customer checked out of a retail store. Each field 75 includes a UCC Product Code and transaction price. Generator 105 stores field 75 in association with a respective matched field 77, to generate records 106. Field 77 is to record whether the particular transaction item has been matched against an invoice indicated by records 104.

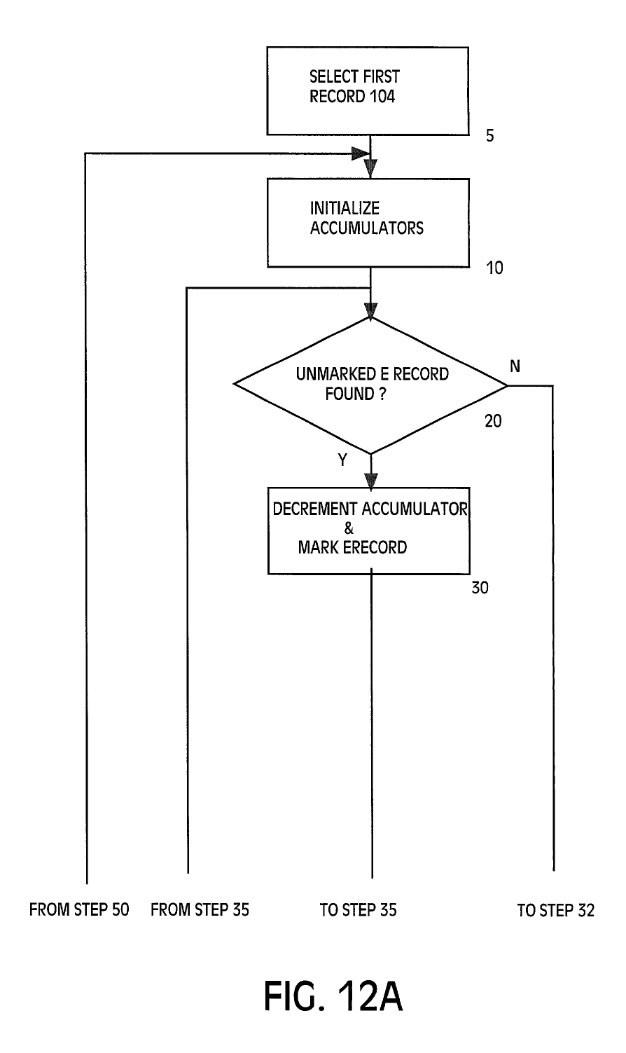

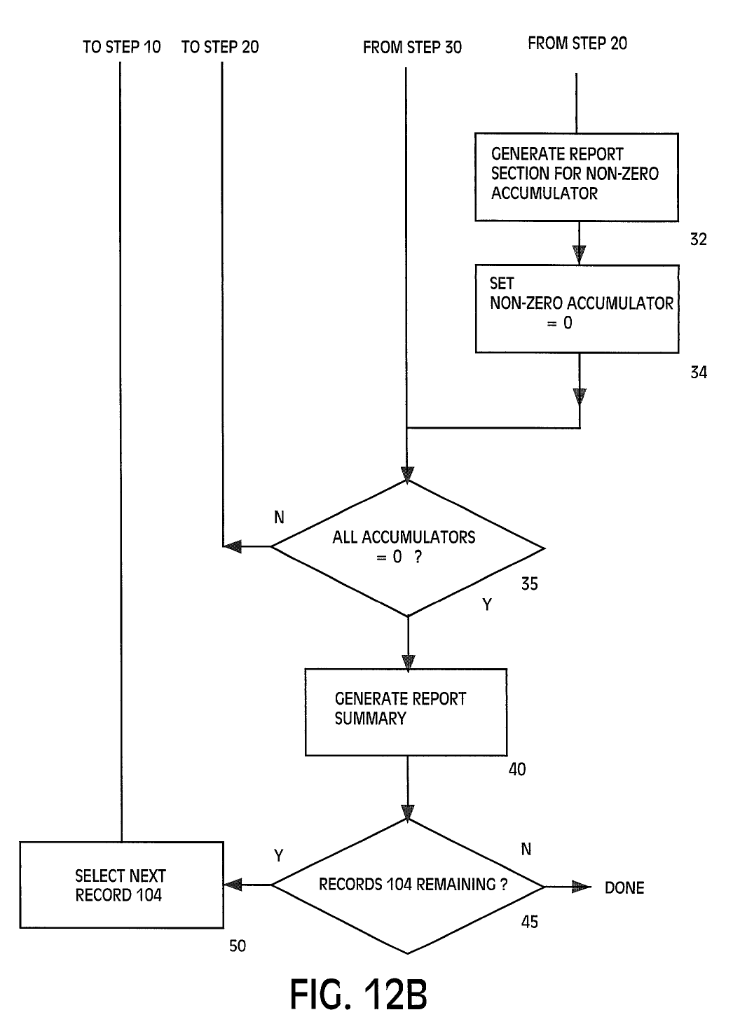

FIGS. 12A and 12B show processing formed by generator 102 shown in FIG. 9. Generator 102 selects a first record in records 104. (step 5). For each type of product in the current record 104, generator 102 sets a respective accumulator equal to the amount of reimbursement request for that product. (step 10).

Generator 102 searches records 106 for an unmatched record 75 (“E record”) corresponding to a non-zero accumulator. Such a record field 75 will have an associated matched field value 77 of 0, and will be contained in a record 93 having a date-time field 73 within the range of the date field 65 of the current record 104. The range may be, for example, the month preceding the date in field 65. If such a record is found (step 20), generator 102 decrements the corresponding accumulator by the difference between the transaction price in field 75 and the normal price for the product, and marks the field 75 by setting matched value field 77 equal to TRUE (step 30).

If any remaining accumulators are non-zero (step 35), generator 102 passes control to step 20. Alternately, if there are no non-zero accumulators remaining (step 35), all reimbursement requests recorded by the current record 104 have been confirmed by records 106 or reported as excess in step 32. Generator 102 than generates a report summary.

Referring again to step 20, if generator 102 does not find an unmatched record 75 corresponding to the non-zero accumulator being processed, control passes to step 32. Generator 102 generates a report section to report the excess. (Step 32). Generator 102 sets the accumulator, corresponding to the excess reported in step 32, equal to zero. (Step 34). Control then passes to step 35.

Generator 102 tests to see whether there are remaining records 104 (step 45), selects the next record 104 if there are records remaining (step 50), and passes control to step 10.

Systems 21 and 31 in station 304 have the same circuitry as systems 20 and 63, respectively. Systems 16 and 33 in station 305 have the same circuitry as systems 20 and 63, respectively.

Each of stores 53, 68, 58, and 59 has the circuitry of store 54 disclosed above.

Additional advantages and modifications will readily occur to those skilled in the art. The invention in its broader aspects is therefore not limited to the specific details, representative apparatus, and illustrative examples shown and described. Accordingly, departures may be made from such details without departing from the spirit or the scope of Applicants'general inventive concept. The invention is defined in the following claims. In general, the words “first,” “second,” etc., employed in the claims do not necessarily denote an order.

What is claimed is:

1. A method for a system including a retailer, and a plurality of manufacturers each associated with a respective product, the method comprising:
enabling a price adjustment for a first purchase with the retailer;
effecting the first purchase with the retailer;
generating a first signal corresponding to the first purchase and sending the first signal on a first signal path;
generating a second signal corresponding to the first purchase and sending the second signal on a second signal path;
receiving the first signal from the first signal path, and the second signal from the second signal path; and
processing the first and second signals received in the previous step, to generate a third signal corresponding to an offset of funds between a selected manufacturer and the retailer, wherein the manufacturer is selected depending on a product subjected to the first purchase.

2. The method of claim 1 wherein the system includes a store having shelves, products on the shelves, and a display supported by one of the shelves, the display displaying a discount level for a product, and the method further includes effecting the first purchase in accordance with the display.

3. The method of claim 1 wherein the system further includes a second retailer, and the method further includes
enabling a price adjustment for a second purchase with the second retailer;
effecting the first purchase with the second retailer;
generating a fourth signal corresponding to the second purchase;
generating a fifth signal corresponding to the second purchase;
processing the fourth and fifth signals, to generate a signal corresponding to an offset of funds between the selected manufacturer and the second retailer.

4. The method of claim 3 wherein the second retailer is in competition with the first retailer.

5. The method of claim 1 wherein the plurality of manufacturers include a first manufacturer having a computer system storing a first monetary amount, corresponding to the price adjustment, and a second monetary amount corresponding to a different system of discounts for the product.

6. The method of claim 1 wherein the retailer includes a plurality of stores each located in a respective building, and receiving the first signal includes
receiving a plurality of first signals from the plurality of stores.

7. The method of claim 1 wherein the system further includes a checkout station, the first signal path begins at the checkout station and the second signal path begins at the checkout station.

8. In a first system including a retailer, and a plurality of manufacturers each associated with a respective product, a processing system comprising:
a generator, in the retailer, that generates a first signal corresponding to a price-adjusted first purchase with a retailer and sending the first signal on a first signal path;
a generator, in the retailer, that generates a second signal corresponding to the price-adjusted first purchase and sending the second signal on a second signal path; and
a processor that receives the first and second signals, to generate a signal corresponding to an offset of funds between a selected manufacturer and the retailer, wherein the manufacturer is selected depending on a product subjected to the first purchase.

9. The processing system of claim 8 wherein the first system includes a store having shelves, products on the shelves, and a display supported by one of the shelves, the display displaying a discount level for a product, and the method further includes effecting the first purchase in accordance with the display.

10. The processing system of claim 8 wherein the first system further includes a second retailer, and the method further includes
a generator, in the second retailer, that generates a fourth signal corresponding to a price-adjusted second purchase with the second retailer and sending the first signal on a first signal path; and
a generator, in the second retailer, that generates a fifth signal corresponding to a price-adjusted second purchase and sending the second signal on a second signal path,
wherein the processor receives the fourth and fifth signals, to generate a signal corresponding to an offset of finds between the selected manufacturer and the second retailer.

11. The processing system of claim 10 wherein the second retailer is in competition with the first retailer.

12. The processing system of claim 8 wherein the selected manufacturer includes a computer system storing a first monetary amount, corresponding to the price adjustment, and a second monetary amount corresponding to a different system of discounts for the product.

13. The processing system of claim 8 wherein the retailer includes a plurality of stores each located in a respective building, and the processor acts to receive a plurality of first signals from the plurality of stores.

14. The processing system of claim 8 wherein the first system further includes a checkout station, the first signal path begins at the checkout station and the second signal path begins at the checkout station.

15. In a first system including a retailer, and a plurality of manufacturers each associated with a respective product, a processing system comprising:
means for enabling a price adjustment for a first purchase with the retailer;
means for effecting the first purchase with the retailer;
means for generating a first signal corresponding to the first purchase and sending the first signal on a first signal path;
means for generating a second signal corresponding to the first purchase and sending the second signal on a second signal path;
means for receiving the first signal from the first signal path, and the second signal from the second signal path; and
means for processing the first and second signals received in the previous step, to generate a signal corresponding to an offset of funds between a selected manufacturer and the retailer, wherein the manufacturer is selected depending on a product subjected to the first purchase.

16. The processing system of claim 15 wherein the first system includes a store having shelves, products on the shelves, and a display supported by one of the shelves, the display displaying a discount level for a product, and the method further includes effecting the first purchase in accordance with the display.

17. The processing system of claim 11 wherein the first system further includes a second retailer, and the method further includes
means for enabling a price adjustment for a second purchase with the second retailer;
means for effecting the first purchase with the second retailer;
means for generating a fourth signal corresponding to the second purchase; and
means for generating a fifth signal corresponding to the second purchase,
wherein the means for processing receives the fourth and fifth signals, to generate a signal corresponding to an offset of funds between the selected manufacturer and the second retailer.

18. The processing system of claim 17 wherein the second retailer is in competition with the first retailer.

19. The processing system of claim 17 wherein the selected manufacturer includes a computer system storing a first monetary amount, corresponding to the price adjustment, and a second monetary amount corresponding to a different system of discounts for the product.

20. The processing system of claim 17 wherein the retailer includes a plurality of stores each located in a respective building, and means for receiving the first signal acts to receive a plurality of first signals from the plurality of stores.

21. The processing system of claim 17 wherein the first system further includes a checkout station, the first signal path begins at the checkout station and the second signal path begins at the checkout station.
